(19) United States
(12) Patent Application Publication
(10) Pub. No.: US 2008/0086261 A1
(43) Pub. Date: Apr. 10, 2008

(54) LOCATION-BASED SOCIAL INTERACTION NETWORK

(75) Inventors: Merle Michael Robinson, Redmond, WA (US); Eric James Hennings, Seattle, WA (US)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: ICEBREAKER, INC., (US)

(21) Appl. No.: 11/855,927

(22) Filed: Sep. 14, 2007

Related U.S. Application Data
(60) Provisional application No. 60/825,851, filed on Sep. 15, 2006.

(51) Int. Cl. G01C 21/00; G06F 15/16; G06F 17/30; G06N 5/00

(52) U.S. Cl. 701/200; 706/45; 707/5; 709/206

(57) ABSTRACT

Systems (and corresponding methods) that enable location-based information to be incorporated within a social networking environment are provided. More particularly, the innovation can track locations and trigger notifications to users with regard to persons of interest within their proximate locale. In aspects, ‘proximate’ can be defined by a user and stored within a personal profile together with other person of interest criteria. By entering this information into a user's profile, it can be possible to locate candidates and potential persons of interest.

### CROSS-REFERENCE TO RELATED APPLICATIONS

This application claims the benefit of U.S. Provisional Patent application Ser. No. 60/825,851 entitled ‘MOBILE SOCIAL NETWORK’, filed on Sep. 15, 2006 and is related to Serial No. entitled ‘SOCIAL INTERACTION SYSTEM’, filed on Jul. 10, 2006, and to U.S. patent application Ser. No. ______ entitled ‘SOCIAL INTERACTION MESSAGING AND NOTIFICATION’, filed on ______, and to U.S. patent application Ser. No. ______ entitled ‘SOCIAL INTERACTION GAMES AND ACTIVITIES’, filed on ______, and to U.S. patent application Ser. No. ______, entitled ‘SOCIAL INTERACTION TAGGING’, filed on ______, and to U.S. patent application Ser. No. ______ entitled ‘DATE MANAGEMENT WITHIN A SOCIAL INTERACTION NETWORK’, filed on ______. The entireties of the above-noted applications are incorporated by reference herein.

### BACKGROUND

The Internet continues to make available ever-increasing amounts of information which can be stored in databases and accessed therefrom. Additionally, with the proliferation of portable terminals (e.g., notebook computers, cellular telephones, personal data assistants (PDAs), smart-phones and other similar communication devices), users are becoming more mobile, and hence, more reliant upon information accessible via the Internet. Accordingly, the connectivity available via the Internet is frequently used to chat, socialize and communicate with friends and family.

One particular area in which the Internet is becoming popular is in the field of Internet dating and other social interaction services generally. An Internet dating service, or online dating, allows people to meet and get acquainted online thereafter potentially engaging in a romantic relationship. Conventional dating services are oftentimes moderated by a third party who matches candidates based upon criteria and/or preferences.

These online dating services enable a user to create a profile which can contain information relating to physical as well as personal characteristics. As well, these online dating services enable a user to search profiles of other candidates in order to locate a match based upon a predetermined set of criterion. For example, a user can search upon physical characteristics such as age, height, weight, hair color, etc. As well, personal characteristics such as income, interests, hobbies, religion, etc. can be used to search profiles.

Online dating or Internet dating continues to expand in popularity as more and more people become acquainted with the Internet and its vast communication resources. Effectively, the seemingly anonymity of the Internet alleviates much of the apprehension and pressures associated with face-to-face communication felt by many individuals.

Online dating or internet dating services enable people to meet online and possibly develop a friendship, a romantic or even sexual relationship. These online dating services enable individuals to provide personal information, for example, age, gender and location. Accordingly, the services promote others to search these individuals using the profile criteria. As well, many dating services allow members to include a photo in their profile which can be searched by others.

In general, online dating services operate by the same criteria as typical relationships. However, factors specific to the nature of online communications may affect the experience. There are many positive factors that can inherently enhance the online experience. For example, online dating sites facilitate individuals to meet more people than they would without such sites. As well, online matchmaking sites enable individuals to easily browse other members' profiles before deciding to initiate communication.

Essentially, these online dating services enable users to break down geographic barriers while enabling users or members to learn more about a prospect or candidate before actually expending the time and effort to pursue a meeting. In today's busy society, the value added by the ability to pre-screen candidates is very desirable.

Conventional dating services have begun to migrate into today's mobile society. More particularly, recent developments have been directed to employing matchmaking services via mobile devices such as cell phones, smart-phones, etc. However, because these conventional mobile systems are nothing more than a mobile version of the traditional Internet dating systems, they have been plagued with slow response time, widespread deception and lack of interactivity.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises systems (and corresponding methods) that enable location-based information to be incorporated within a social networking environment. More particularly, the innovation can track locations and trigger notifications to users with regard to persons of interest within their proximate locale. In aspects, ‘proximate’ can be defined by a user and stored within a personal profile together with other person of interest criteria.

In aspects, the innovation extends the capabilities of mobile social services to include Location Based Services (LBS). LBS can be used to alert interested parties that they are physically close to other persons of interest. LBS can also be used to help users create and/or edit their profiles by auto-entering location information into the profile. By entering this information into a user's profile, it is possible to locate candidates and potential persons of interest.

Essentially, the innovation extends mobile social services to include LBS technology. Aspects are directed to creating automatic location-based metadata when creating/editing user profiles. Other aspects employ this location-based information to make physical world introductions of users.

The innovation can alert interested parties within some defined distance. In other words, interested parties within a defined radius can be notified of the other party's presence. Additionally, the innovation can enable mapping capabilities to be used to assist users to locate each other. These mapping capabilities can be graphical, textual or audible (e.g., spoken directions).

Yet other aspects provide for ‘lock-on’ seek capabilities. Once users are notified of each others close proximity, they can agree to use a ‘lock-on’ service. This service can assist two users to navigate towards each other (or away if desired). This can be accomplished with or without a map in alternative aspects. Without a map, an application can provide a mixture of sounds and/or screen clues to tell the user that they are getting closer or not. The service can also instruct users to move right, left, forward or backward. With the map, those same directions will be easy to track.

In yet another aspect thereof, contextual awareness and/or machine learning & reasoning (MLR) components are provided that employ a probabilistic and/or statistical-based analysis to infer an action that a user desires to be automatically performed. For example, MLR can be employed to automatically track users and/or generate location limits for notification.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates a system that facilitates location-based social matching in accordance with an aspect of the innovation.

FIG. 2 illustrates an example flow chart of procedures that facilitate location-based candidate identification in accordance with an aspect of the innovation.

FIG. 3 illustrates an example flow chart of procedures that facilitate profile generation and location-based matching in accordance with an aspect of the innovation.

FIG. 4 illustrates an example block diagram of a communication system that enables location-based networking in accordance with an aspect of the innovation.

FIG. 5 illustrates an example block diagram of an alternative communication system that facilitates location-based tracking and notification in accordance with an aspect of the innovation.

FIG. 6 illustrates an alternative communication system that facilitates mapping, ‘lock-on’ and query management in accordance with aspects of the innovation.

FIG. 7 illustrates an example communication system diagram that employs contextual awareness and/or machine learning & reasoning logic to automate one or more features of the innovation.

FIG. 8 is a schematic block diagram of an example portable handheld device according to one aspect of the subject innovation.

FIG. 9 illustrates a block diagram of a computer operable to execute the disclosed location-based architecture.

FIG. 10 illustrates a schematic block diagram of an example computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms ‘component’ and ‘system’ are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to ‘infer’ or ‘inference’ refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Mobile social networking services, such as mobile dating applications, assist users form relationships that can eventually lead into the physical world. Conventional systems do not provide viable options to gain a physical introduction to other potential friends or dates that might be in close physical proximity. The subject innovation employs location-based information to enhance connecting users with candidates. In one example, location information accessed by way of global positioning systems (GPS) can be employed to determine a user's location as well as potential candidates of interests within a defined radius from the user. This and other examples will be described in more detail in connection with the figures that follow.

The subject innovation discloses extending the capabilities of mobile social services to include Location Based Services (LBS). As will be understood, LBS is becoming integrated into most mobile devices (e.g., cell phones, smart-phones . . . ). In other words, many service providers and device manufacturers have begun to incorporate GPS into devices at no charge. As well, many service carriers require e911 to be required in order to track devices in situations of emergency. The subject innovation leverages this LBS functionality within the social networking environment. In aspects, LBS can be used to alert interested parties that they are physically close in distance. LBS can also be used to help users create and/or edit their profiles by auto-entering location information into the profile.

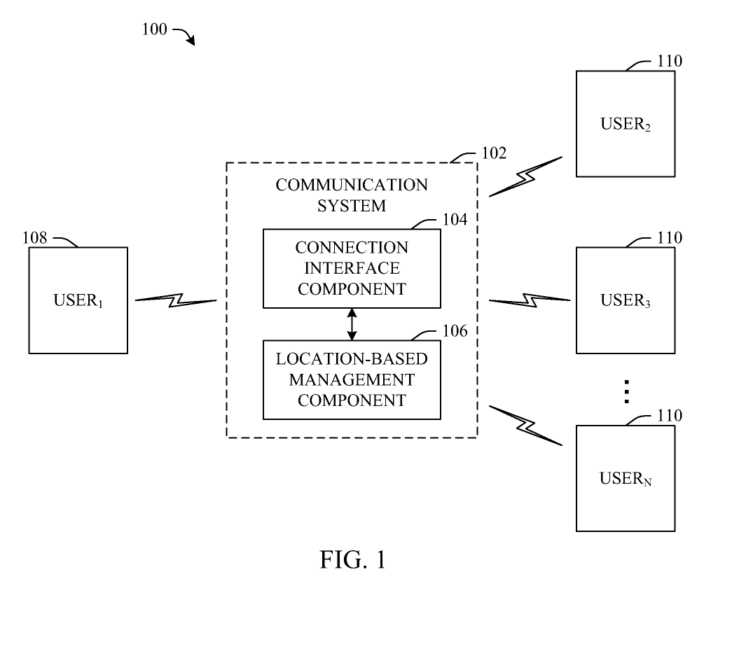

Referring initially to FIG. 1, the subject innovation is directed to a system 100 (and associated methods) that facilitates location-based functionalities of a social interaction system. As illustrated, the system 100 can include a communication system 102 having a connection interface 104 and a location-based management component 106. Together, these components manage and enable identifying a user of other closely-located candidates that are of interest or may be of interest. It will be understood that ‘closely-located’ can be defined as most any desired distance. Still further, the innovation enables users to broadcast their location such that other network-connected candidates can track the user.

Essentially, a first user 108 can be notified of nearby candidates or send messages to other strategically located users 110 within the network via the communication system 102. The location-based management component 106 can be used to manage candidate locations and to effect conveying useful information to users in order to assist in managing social networking functionalities.

The connection interface 104 enables many of the core functionalities of a social interaction service. For instance, the connection interface 104 can maintain user/member profiles, contact information, preferences, policies, etc. In other words, the connection interface 104 can provide mechanisms and means for users to locate each other by browsing personal characteristics, interests, locations, preferences, etc. of other users, members or subscribers. More particularly, in accordance with the innovation, a user can identify their location, preferred locations, alternate locations, etc. within the profile. Thereafter, the connection interface component 104 can be employed to identify candidates in proximity to the user based upon profile information.

Still further, users can opt to have their location data dynamically updated. In these scenarios, it can be possible for a user to define a radius by which candidates can be identified. Here, the communication system 102 can automatically connect users within a defined radius or distance, or otherwise notify one or both of the parties of location of another party.

In addition to providing the core social networking functionality, the connection interface 104 can also provide query, search and filter capabilities. These capabilities enable members to be logically matched based upon similarities, preferences, policies or the like. As will be described below, most any functionality of the system 100 (including the connection interface component 104), can be enhanced by the use of sophisticated logic mechanisms such as machine learning & reasoning (MLR) logic mechanisms. In these examples, the system 100 can learn, e.g., based upon statistics, history, feedback, etc., and can automatically act on behalf of a user.

The location-based management component 106 injects LBS information into the social networking environment. This sophisticated LBS social networking experience adds yet another dimension to enhance an individual's ability to reach others in a local or commutable distance. Of course, most any distance is commutable. However, it will be understood that, information provided and managed by the location-based management component 106 enables a user to locate individuals (e.g., candidates, friends) that are within a desired distance at any given time.

While many examples are described herein, it is to be understood and appreciated that other examples of LBS social networking scenarios exist—which are to be considered within the scope of this innovation. By way of specific example, while a user can employ a cellular telephone to effect the LBS functionality described herein, it is to be understood that most any device can be employed in alternative aspects. For instance, examples that employ smart-phones, personal digital assistants (PDAs), laptops, personal computers (PCs), or the like are to be included within the innovation described herein.

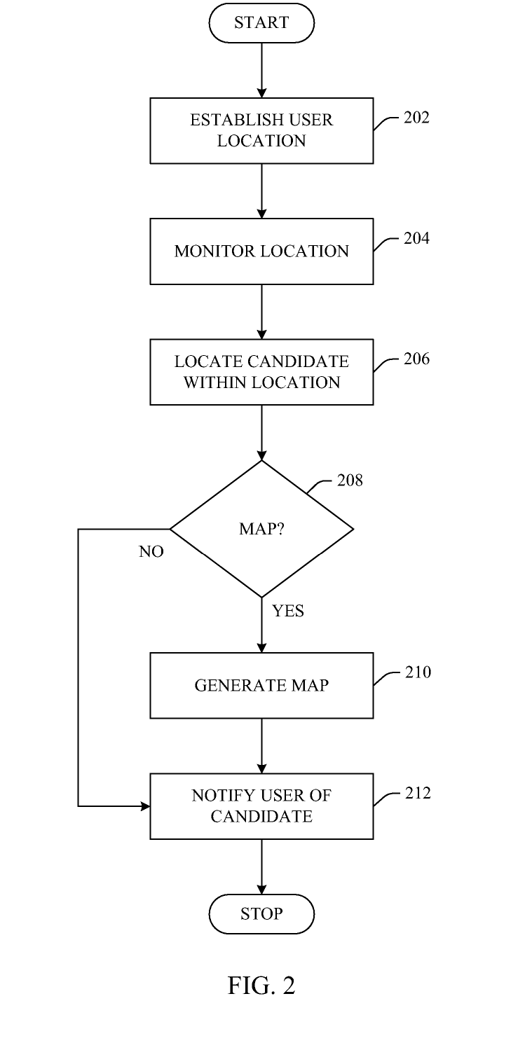

FIG. 2 illustrates a methodology of incorporating LBS into a social interaction environment in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 202, location of a user can be established. In this methodology, the location can be dynamically monitored, for example, by way of a GPS-equipped mobile device or the like. In other aspects, users can affirmatively state their location. Still further, a user can affirmatively identify a future location, for example a business trip on September 15^{th} to Pittsburgh. Moreover, personal information manager (PIM) data or other scheduling application data can be used to presumptively determine a user location.

At 204, once the location is established, the system can monitor the location for activity related to members of a social network or some subset thereof. For instance, if the established location from 202 is a park in Pittsburgh, Pa., the geographic area (including some additional radius if desired) can be monitored to identify candidates that enter the defined geographical space.

A candidate can be located at 206—for example, a candidate that meets the user's defined criteria. By way of specific example, suppose the user defines in his profile that he is in search of single women between the ages of 18 and 25. Here, when a candidate that meets this criterion comes within the LBS defined range, the candidate will be identified at 206.

At 208, a determination is made to decide if the candidate should be mapped in relation to the user's location. It is to be understood that mapping can be a personal choice (e.g., defined in a profile) or set as a default by a networking service in disparate aspects. If a determination is made to map the location, the map is generated at 210. Here, most any map can be generated that is capable of providing directions from the user to the candidate (or vice-versa).

Next, at 212, the user is notified of the candidate that is within the defined range. As illustrated, at 212, the user can be provided with a map if desired. It is to be understood that policies and preferences can be set within a user profile. For example, a searcher user can define their profile to generate a map. Similarly, a candidate, for at least security reasons, can prohibit mapping or other pinpointing by way of a profile policy. These and other profile criteria will be described in connection with the figures that follow.

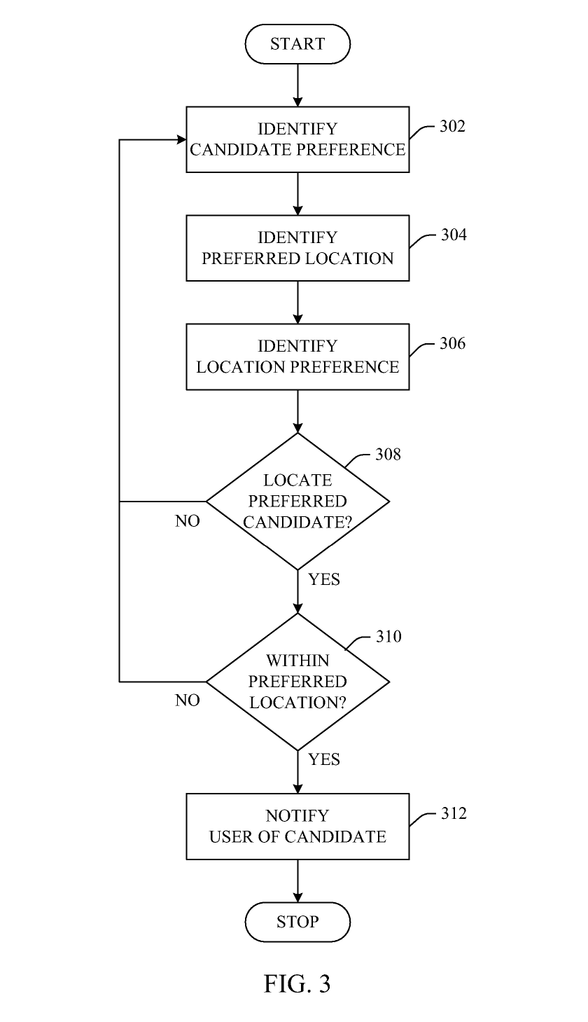

FIG. 3 illustrates a methodology of the employing a policy, preference and/or rule with respect to LBS candidate tracking in accordance with an aspect of the innovation. At 302, a user can identity a candidate preference. Here, the user identifies criteria by which candidates are located. For instance, a user can search for all single women between the ages of 18 and 25 years old. It is to be understood that most any criteria specified in order to search for candidates can be established—these alternative aspects are to be included within the scope of the disclosure and claims appended hereto.

At 304, a preferred location can be identified by the user. In this act, the user can identify a location by which candidates should be searched. In one example, this preferred location can define a radius around a city or other location. In other aspects, the preferred location can be a specific city, state, building, park, amusement park, etc. In other words, the granularity of the preferred location can be of most any desired by a user.

Still further, the preferred location can be defined as, for example, X miles from a user's current location. Here, it will be appreciated that the range is dynamic in that GPS location detection or other suitable location determination systems can be used to determine the current location, thereby, determining the acceptable distances. Thus, candidates can be located within the defined geographical range.

At 306, a candidate (or group of candidates) with the preferred (or defined) criteria (e.g., single women between 18 and 25 years of age) is identified at 306. At 308, it is determined if a candidate that matches the defined criteria is a preferred candidate. If not, the methodology returns to 302 to revise candidate preference(s).

However, if a preferred candidate is located, next a determination can be made at 310 to conclude if the candidate is within the preferred location. If the candidate is not located within the preferred location, the methodology returns to 302 to revise candidate preference(s). If the candidate is within the preferred location, at 312, the user is notified of the candidate.

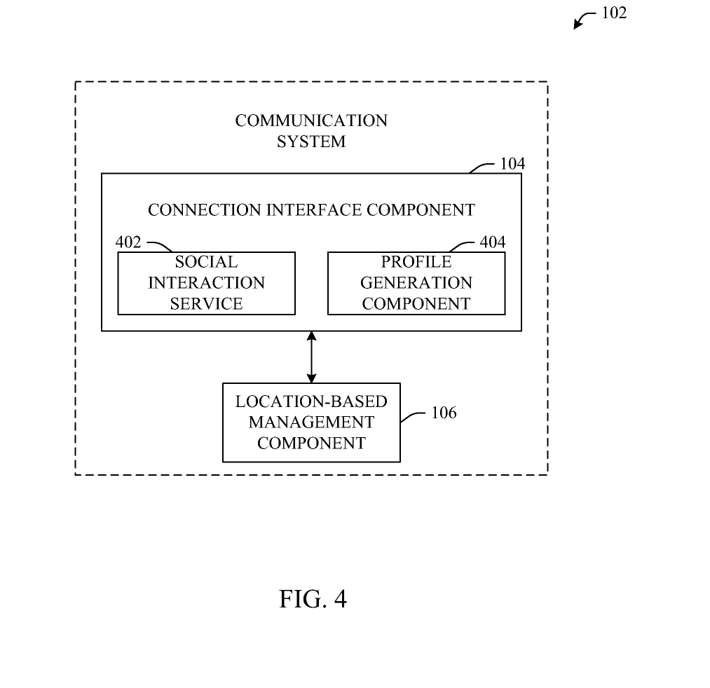

Turning now to FIG. 4, an alternative block diagram of communication system 102 is shown. As described with reference to FIG. 1, the communication system 102 can include a connection interface component 104 and location-based management component 106. As shown in FIG. 4, the connection interface component 104 can include a social interaction service 402 and a profile generation component 404. Each of these components will be described in greater detail infra.

Although the social interaction service component 402 and the profile generation component 404 are shown inclusive of the connection interface component 104, it is to be understood that these components 402, 404 can be located external and/or remote from the connection interface component 104 (and communication system 102) in alternative aspects.

In one particular aspect, the social interaction service component 402 can be representative of a social networking or mobile dating service where members/candidates can define a profile and/or browse profiles of other members/candidates. Although a mobile dating service is described herein, it is to be understood that the features, functions and benefits of the innovation (e.g., messaging and notification) can be employed in other scenarios where an application or service is used to locate, notify and/or effect communication between individuals.

The connection interface component 104 can also include a profile generation component 404 which enables a user to define preferences and/or policies associated with preferred candidates ultimately located by the social interaction service 402. For instance, a user can select parameters that define which candidates to search/query profiles based upon gender, marital status, age, geographic location, among others. Similarly, the profile generation component 404 enables a user to define other settings such as notification protocol preferences, messaging protocol preferences, acceptable time windows to receive notifications, acceptable devices, email addresses, phone numbers, etc. to receive notifications and/or messages. These examples are described in detail with reference to the Related Applications that are incorporated by reference above.

In addition to personal criteria of sought candidates, the profile generation component 404 enables a user to define a geographic location and/or radius by which to search for candidates. Still further, the profile can define when/if to generate a map, how granular to display locations together with preferred candidates, etc. These and other examples will become more apparent upon a review of the figures that follow.

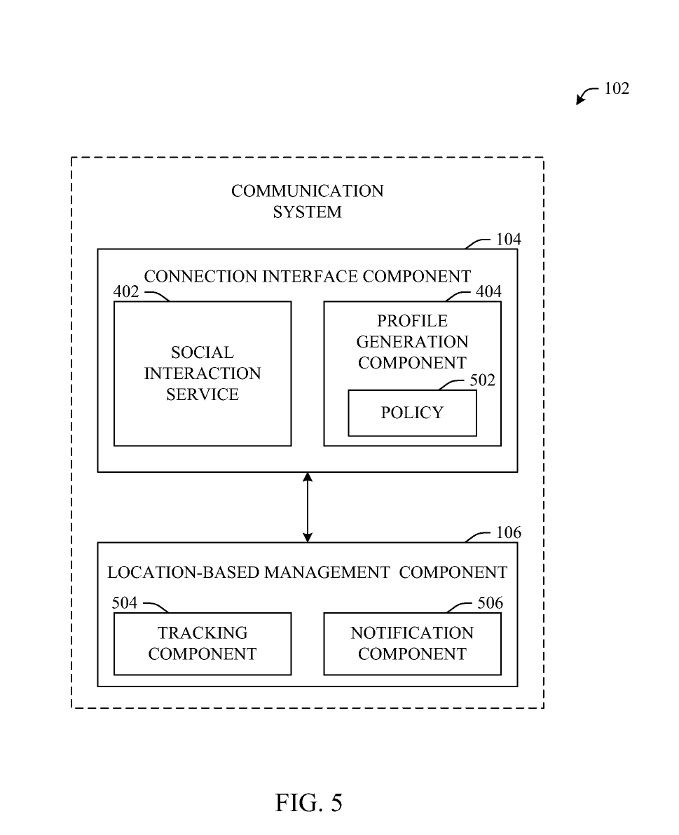

FIG. 5 illustrates yet another example block diagram of communication system 102. As shown, and as described above, the profile generation component 404 can include a policy 502 (e.g., rules logic) which can be employed to manage a user's social networking experience. The policy component 502, in addition to defining descriptive characteristics of preferred candidates, can define location-based information. This location-based information can define a ‘home’ location, a ‘preferred’ location, a ‘location radius’ or the like.

With continued reference to FIG. 5, the location-based management component 106 can include a tracking component 504 and a notification component 506. Essentially, the tracking component 504 monitors candidates within a location defined by the policy component 502. Upon locating candidates that meet a defined (or inferred) policy 502, the notification component 506 can be used to alert either (or both of) the user and/or candidate.

As described above, the innovation extends traditional social interaction services to employ LBS technologies. These LBS technologies can enhance traditional networking services by creating automatic metadata when creating/editing user profiles as well as making physical world introductions of users as a function of preferred and current (or future) geographic locations.

The profile generation component 404 can communicate with the location based management component 106 to automatically or dynamically update the policy 502. Here, the service can create automatic personal metadata based upon input from LBS. This metadata can be used for profile updates, entries and/or edits. As well, the metadata can be employed to effectuate matching profiles to criteria.

When the user creates a profile (e.g., via profile generation component 404), the client can use the LBS data to suggest a location. If the user deems this information as correct or acceptable, it can be entered without edit in the profile—saving time for the user. Also, if the user has already created a profile, the application can help the user set up a traveling profile if LBS shows him/her to be a large distance away (e.g., greater than 200 miles) from the previously set location.

As the user goes about his or her life, he/she may frequent certain locations quite often. If he/she wishes, the tracking component 504 can track his/her local travel patterns, and then suggest suitable mates within the community. It will be appreciated that this functionality can be effectuated by way of machine learning & reasoning logic. It will be appreciated that, the location-based management component 106, by way of the notification component 506, can alert of other users that have visited a similar location in the past. This notification can be made possible by the monitoring of information by the tracking component 504. For example, the notification component 506 can inquire to the effect, ‘would you like to meet others who have visited similar physical locations?’

In additional to profile management and historical tracking, the location-based management component 106 can also facilitate physical world introductions. The service can help users in real-time, by alerting them to other community members that are nearby and by directing users to each others with maps, signals, etc. In other words, the tracking component 504 can be employed to monitor users and thereafter alert users of other ‘compatible’ users within a defined ‘proximate’ distance (e.g., as defined by a profile policy 502).

In one example, the notification component 506 can be employed to alert interested parties within some defined distance. It is to be understood that the alert can be based upon some predefined interest (e.g., ‘crush’) or a determination of a potential interest as determined or inferred from the policy 502, as well as learned feedback. In operation, the LBS (e.g., location-based management component 106) can alert two ‘interested parties’ when they are within some physical distance or radius from each other or other location.

It will be appreciated that this capability can be very powerful to ‘break the ice’ for an existing virtual relationship and/or a completely new relationship as both parties scan and are made aware of the location for each other. ‘Interested parties’ refer to a users that have mutually agreed on the notification in that one user has agreed to be tracked and the other user has agreed to be notified. This designation can be used to automatically prompt notification. However, in other aspects, users can be anonymously made aware that there exist potential candidates within a proximate locale. Here, if mutually agreed, the system can trigger notification.

The notification component 506 can deliver notifications as defined by a user (or otherwise determined on behalf of a user). For example, service conditions employed by the notification component 506 provide preferences for how users desire to be notified—e.g., through a text message, voice call, sound, email, instant message, application launch, etc. As described above, users can define maximum distance for notification (e.g., 100 feet or even a few miles). It will be understood that countless examples exist that employ incorporation of LBS into the social networking experience. These examples are to be included within the scope of the innovation and claims appended hereto.

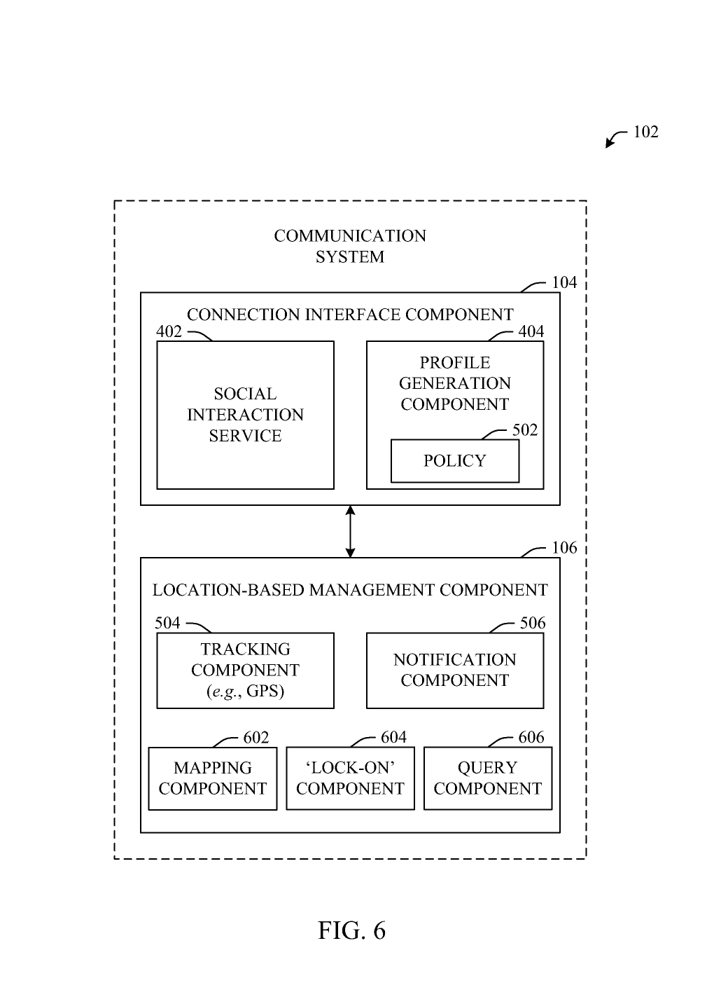

Turning now to FIG. 6, an alternative block diagram of a communication component 102 is illustrated in accordance with an aspect of the innovation. More particularly, the location-based management component 106 shown in FIG. 6 includes a mapping component 602, a ‘lock-on’ component 604 and a query component 606. Features, functions and benefits of these components will be described in greater detail below.

Referring first to the mapping component 602, this component enables a user to generate a map to a candidate or group of candidates. Additionally, the mapping component 602 can establish maps that illustrate a how many candidates are in a given region or locale. In one aspect, users can employ a mapping component 602 to generate and render a map on their display. Alternatively, text or voice-based directional instructions can be provided. In either case, the map can denote the positions, altitudes and velocities of both parties. As will be understood, the map can assist users to identify each other within their location radius, especially if they are within visual range.

In addition to providing navigational maps and instructions, the location-based management component 106 can include a ‘lock-on’ component to further assist in locating candidates and persons of interest. In one embodiment, once users are notified of each other's close proximity, they can agree to employ the ‘lock-on’ service. The service of the ‘lock on’ component 604 can assist two (or more) users navigate toward each other.

In aspects, ‘lock on’ navigation can be accomplished with or without a map. Without a map, the component 604 can provide a mixture of sounds and/or screen clues to tell the user if they are getting closer or not. The service can also use voice command to instruct users to go ‘right,’ ‘left,’ ‘forward,’ or ‘backward.’ With the map, it will be understood that those same directions will be easy to track.

The query component 606 can be employed to enable a user to locate candidates or persons of interest within a particular locale or geographic region. As a user searches through potential interested parties (e.g., via query component 606) or is matched via some algorithm, that user can be notified that the matched party is very close, e.g., some short distance or travel time. For example, the user can be notified (via notification component 506) that the person is ‘only 5 miles away’ or ‘only 10 minutes away.’

The query component 606 can also provide for search sorting capabilities. In examples, query search results can list location (or distance from user) in a column of the search results. If desired, users could even sort under that information. For security, as appropriate, users can prevent location information from being shown, or can control the resolution of that information (e.g., location information will not be shown to less than 20 miles). Preferences include, but are not limited to: all, by user, by type of user (friend or stranger), and by distance.

Essentially, the location-based management component 106 creates community between an on-line or virtual meeting place and the physical world. GPS (or other positioning systems) can enhance both experiences by making users aware of community activity in the real world. As described above, the location-based management component 106 can provide notifications of persons of interest or candidates within a proximate distance.

Other embodiments of the location-based management component 106 can provide identification of locations that contain interesting people. These locations can be rated, for example, best, moderate, few, or the like. It will be understood that one method of connecting users is by letting them know where the most interesting users are located. On a map, top locations for ‘interesting’ users could be marked or designated, without necessarily releasing the identity of the marked users.

‘Interesting’ can be defined by the user preferences, but could refer, for example, to the most attractive users as voted by a subset of registered users. Most any classification can be employed to deem a user as ‘interesting.’ With security in mind, locations could be marked in only those cases where the safety of the users could be assured.

One way to provide security would be by marking users only when their relative user/area density is high enough to avoid detection. This can be done in at least two ways. A first method refers to high density populations. Marking interesting individual users on a map only in locations that have more than some sufficiently large number (e.g., >50) of members on the map at that specific location. This sufficiently large number of members will help to obscure specific user location, if desired.

A second method refers to low density populations. Using a market on the map that is sufficiently large (or the map sufficiently unzoomable) to prevent the identification of a specific user at a specific address. For instance, zooming may be limited so as to ensure a specific number of users displayed within a region. Here, identity can be protected, if desired.

As described above, it will be understood and appreciated that security can be addressed by the innovation. Because real physical harm can occur, default location broadcasting should be set very conservatively. For example, users can set location broadcasting completely off or set approval preferences (e.g., based upon specific profile control lists, common ‘community’ tags, common ‘certified’ tags, or the like). In aspects, these approval preferences include, but are not limited to: all, by user, by type of user (friend or stranger), degree of separation from a common friend, by distance, etc.

While many of the aspects described herein are directed to mobile device implementations, it is to be understood that the features, functions and benefits of the systems can be employed by way of an Internet or other network using a personal computer (PC) or compatible device. These PC-based examples are to be considered within the scope of the disclosure and claims appended hereto.

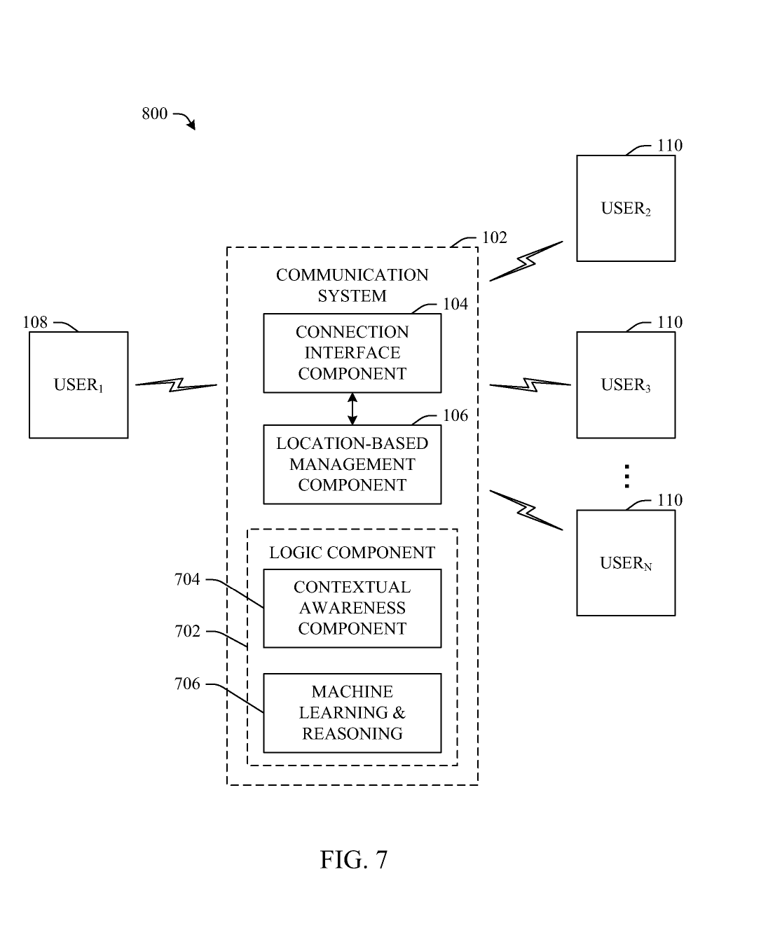

Referring now to FIG. 7, an alternative system 700 in accordance with an aspect of the innovation is shown. Generally, system 700 can include a communication system 102 that regulates LBS discovery and notification to users (e.g., 108, 110) as described herein. More particularly, the communication system 102 can include a connection interface component 104 and a location-based management component 106 (together with subcomponents) as described above. Still further, a logic component 702 having a contextual awareness component 704 and/or a MLR component 706 is provided. This logic component 702 (and optional subcomponents 704, 706) can provide for sophisticated decision-making capabilities of the communication system 102 generally.

In particular, the contextual awareness component 704 can be employed to consider most any contextual factor when employing LBS functionalities described herein. In examples, location, time of day, day of week, etc. can be factored into decisions related to discovery and/or location-based notifications. Still further, factors such as engaged activity, calendar appointments (schedule), tasks, individuals in proximity, upcoming activities, or the like can be factored into decision logic related to discovery and notifications.

By way of specific example, the logic component 702 can access a user's personal information manager (PIM) data in order to establish a current and future location of a user. For instance, if the PIM data indicates that a user is in a meeting at location X and will be travelling by air to location Y, the location-based management component 106 can postpone notification of candidates within proximity to location X. Rather, the system can notify the user of candidates in the target location, location Y. While specific examples are given, it is to be understood most any contextual factor can be considered in the functionality of the communication system 102.

Still further, MLR logic 706 can be employed to automate one or more functions of the communication system 102. For instance, the innovation can employ MLR mechanisms which facilitate automating one or more features in accordance with the subject innovation. The subject innovation (e.g., in connection with identification of ‘interesting’ candidates, etc.) can employ various MLR-based schemes for carrying out various aspects thereof. For example, a process for determining notification protocol selection, granularity, etc. related to LBS social networking can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module.

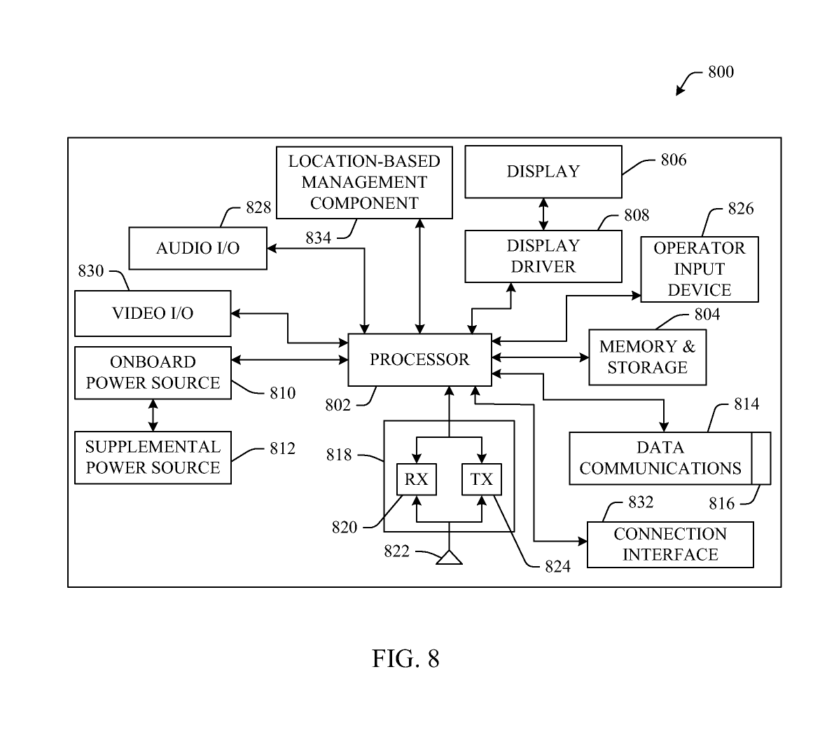

Referring now to FIG. 8, there is illustrated a schematic block diagram of a portable hand-held device 800 according to one aspect of the subject invention, in which a processor 802 is responsible for controlling the general operation of the device 800. The processor 802 can be programmed to control and operate the various components within the device 800 in order to carry out the various novel functions described herein. The processor 802 can be any of a plurality of suitable processors. The manner in which the processor 802 can be programmed to carry out the functions relating to the subject innovation will be readily apparent to those having ordinary skill in the art based on the description provided herein. As described in greater detail supra, contextual awareness and/or MLR components can be used to effect an automatic action (and sophisticated decision-making) of processor 802.

A memory and storage component 804 connected to the processor 802 serves to store program code executed by the processor 802, and also serves as a storage means for maintaining information such as data, services, metadata, device states, electronic mail messages, or the like. The memory 804 can be a non-volatile memory suitably adapted to store at least a complete set of the information that is acquired. Thus, the memory 804 can include a RAM or flash memory for high-speed access by the processor 802 and/or a mass storage memory, e.g., a micro drive capable of storing gigabytes of data that comprises text, images, audio, and video content. According to one aspect, the memory 804 has sufficient storage capacity to store multiple sets of information relating to disparate services, and the processor 802 could include a program for alternating or cycling between various sets of information corresponding to disparate services.

A display 806 can be coupled to the processor 802 via a display driver system 808. The display 806 can be a color liquid crystal display (LCD), plasma display, touch screen display or the like. In one example, the display 806 is a touch screen display. The display 806 functions to present data, graphics, or other information content via a UI. Additionally, the display 806 can display a variety of functions that control the execution of the device 800. For example, in a touch screen example, the display 806 can display touch selection buttons. In operation, when the notifications and/or messages are delivered, the UI, via display 806, can effectively convey the notifications and/or messages to a user. As described above, these notifications and/or messages can be text, visual, audio or combinations thereof.

Power can be provided to the processor 802 and other components forming the hand-held device 800 by an onboard power system 810 (e.g., a battery pack). In the event that the power system 810 fails or becomes disconnected from the device 800, a supplemental power source 812 can be employed to provide power to the processor 802 (and other components (e.g., image capture device)) and to charge the onboard power system 810. The processor 802 of the device 800 can induce a sleep mode to reduce the current draw upon detection of an anticipated power failure.

The device 800 includes a communication subsystem 814 having a data communication port 816, which is employed to interface the processor 802 with a remote computer, server, service, or the like. The port 816 can include at least one of Universal Serial Bus (USB) and IEEE 1394 serial communications capabilities. Other technologies can also be included, but are not limited to, for example, infrared communication utilizing an infrared data port, Bluetooth™, wireless protocols, etc.

The device 800 can also include a transceiver section 818 in operative communication with the processor 802. The transceiver section 818 includes a receiver 820, which receives signals from a remote device via an antenna 822 and can process the signal to obtain digital information therein. The transceiver section 818 also includes a transmitter 824 for transmitting information (e.g., data, service) to a remote device, for example, in response to manual user input via a operator input 826 (e.g., a keypad).

The transceiver section 818 facilitates communication with other portable devices and/or host computer systems. In furtherance thereof, an audio I/O section 828 is provided as controlled by the processor 802 to process voice input from a microphone (or similar audio input device) and can transmit audio output signals (from a speaker or similar audio output device).

In another implementation, the device 800 can provide speech recognition capabilities such that when the device 800 is used as a voice activated device, the processor 802 can facilitate high-speed conversion of the voice signals into text or operative commands. For example, the converted voice signals can be used to control the device 800 in lieu of using manual entry via the keypad 826. As well, in another aspect, voice commands can be employed to effect coupling and/or decoupling from a remote system. Still further, voice activated commands can be employed to ‘crush’ (select) or ‘flush’ (pass) with regard to presented candidates. Most any appropriate functionality of the innovation can be controlled via voice commands.

Similarly, video signals can be input and/or output via the video I/O component 830. The video I/O component 830 can include an image capture device capable of providing video communications via the mobile device 800.

Other components such as a connection interface 832 and location-based management component 834 can be provided within the housing of the device 800 to effectuate functionality described supra. For example, the connection interface 832 can be employed in connection with setting parameters by way of a profile generation component (404 of FIG. 4). As well, the location-based management component 834 can be employed to manage LBS social networking services in accordance with the innovation.

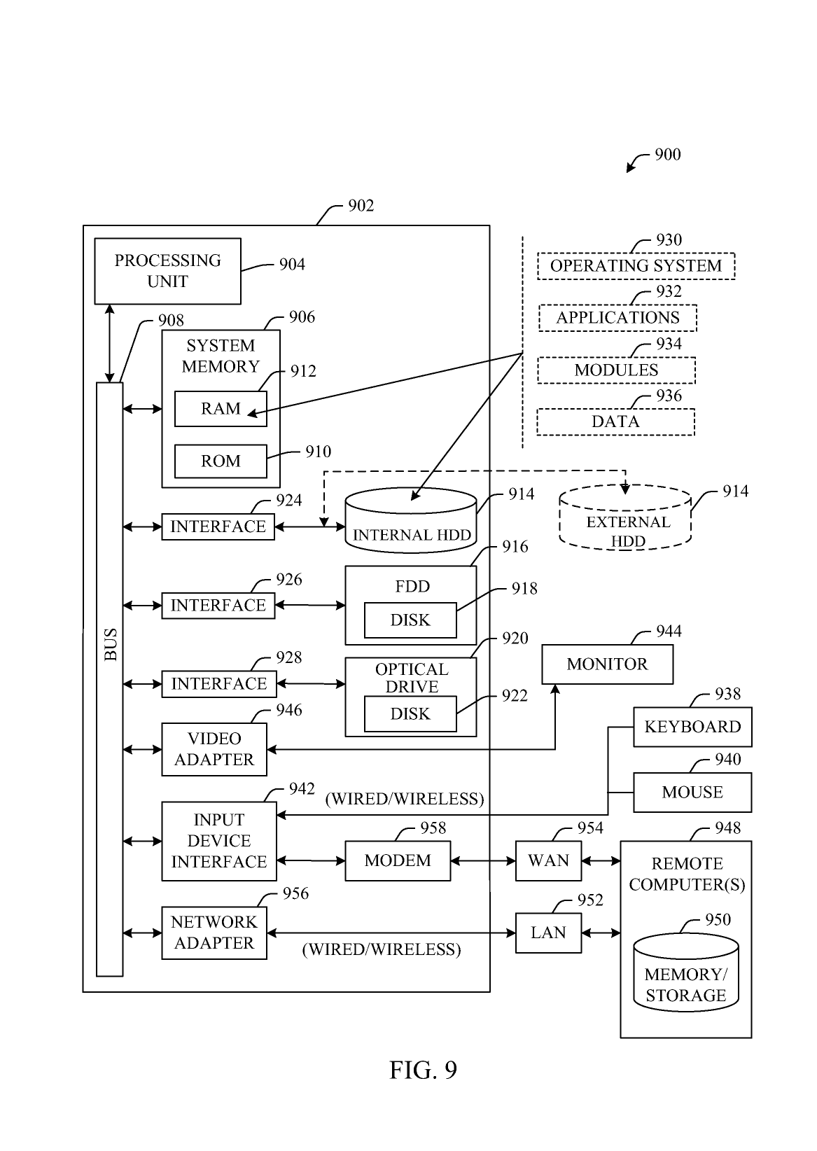

Referring now to FIG. 9, there is illustrated a block diagram of a computer operable to execute the disclosed architecture. In order to provide additional context for various aspects of the subject innovation, FIG. 9 and the following discussion are intended to provide a brief, general description of a suitable computing environment 900 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term ‘modulated data signal’ means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the exemplary environment 900 for implementing various aspects of the innovation includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the innovation can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1394 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adapter 956 may facilitate wired or wireless communication to the LAN 952, which may also include a wireless access point disposed thereon for communicating with the wireless adapter 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

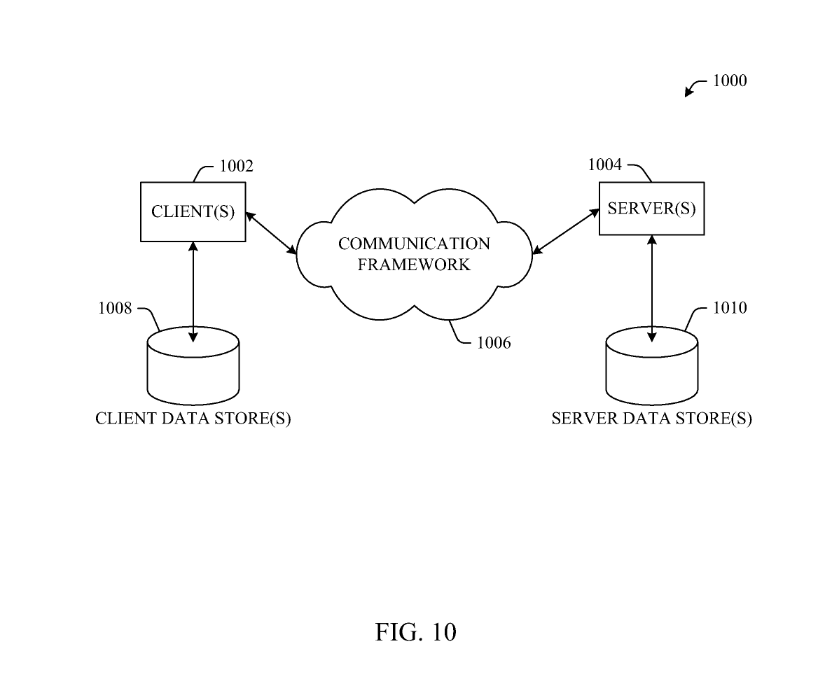

Referring now to FIG. 10, there is illustrated a schematic block diagram of an exemplary computing environment 1000 in accordance with the subject innovation. The system 1000 includes one or more client(s) 1002. The client(s) 1002 can be hardware and/or software (e.g., threads, processes, computing devices). The client(s) 1002 can house cookie(s) and/or associated contextual information by employing the innovation, for example.

The system 1000 also includes one or more server(s) 1004. The server(s) 1004 can also be hardware and/or software (e.g., threads, processes, computing devices). The servers 1004 can house threads to perform transformations by employing the innovation, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term ‘includes’ is used in either the detailed description or the claims, such term is intended to be inclusive in a manner similar to the term ‘comprising’ as ‘comprising’ is interpreted when employed as a transitional word in a claim.

What is claimed is:

1. A system that incorporates location-based services (LBS) into a social networking environment, comprising:
a connection interface component that employs user-defined criterion to identify a plurality of candidates; and
a location-based management component that employs LBS and delivers an alert to a user that identifies locations related to a subset of the plurality of candidates as a function of the location of the user.

2. The system of claim 1, further comprising a profile generation component that enables the user to define the criterion.

3. The system of claim 1, further comprising a tracking component that dynamically tracks and updates the location of the user.

4. The system of claim 1, further comprising a tracking component that dynamically monitors locations of the subset of candidates, wherein the alert reflects location of each of the subset of candidates relative to the location of the user.

5. The system of claim 1, further comprising a notification component that triggers the alert based upon a distance between the user and the subset of candidates, wherein the distance is one parameter defined in by the user-defined criterion.

6. The system of claim 1, the alert is at least one of a text message, an instant message, an email or a voice call.

7. The system of claim 1, further comprising a mapping component that generates a map that identifies the location of the user relative to each of the subset of candidates, wherein the alert conveys the map to the user.

8. The system of claim 1, further comprising a mapping component that identifies a rendering of a plurality of persons of interest in a geographical region, wherein the alert conveys the rendering to the user.

9. The system of claim 1, further comprising a query component that one of sorts, ranks or orders the subset of candidates, wherein the alert conveys the sorting, ranking or ordering to the user.

10. The system of claim 1, further comprising at least one of a contextual awareness component or a machine learning and reasoning component employs at least one of contextual, a probabilistic or a statistical-based analysis that infers an action that the user desires to be automatically performed

11. A computer-implemented method of incorporating location-based logic into a social networking environment, comprising:
determining a plurality of candidates within a social networking environment, wherein the plurality of candidates are identified based upon user-defined criteria in view of location of the user; and
notifying the user of each location of a subset of the plurality of candidates.

12. The computer-implemented method of claim 11, further comprising generating the criteria.

13. The computer-implemented method of claim 11, further comprising dynamically determining the user location.

14. The computer-implemented method of claim 11, further comprising:
generating a map that defines each location of a subset of the plurality of candidates; and
rendering the map to the user.

15. The computer-implement method of claim 11, further comprising:
locking-on to at least one of the plurality of candidates; and
providing directions to the at least one of the plurality of candidates in view of current location of the user.

16. The computer-implemented method of claim 15, wherein the directions are at least one of text, graphical or audio directions.

17. The computer-implemented method of claim 16, further comprising dynamically tracking location of the user and each of the plurality of candidates.

18. A social interaction system, comprising.
means for determining location of a plurality of persons of interest to a user;
means for determining a preferred location of the user; and
means for notifying the user of a subset of the plurality of persons of interest as a function of their location in view of the preferred location of the user.

19. The system of claim 18, further comprising means for dynamically updating the preferred location of the user.

20. The system of claim 19, further comprising means for graphically displaying the location of each of the plurality of persons of interest in view of the preferred user location.
